(19) United States
(12) Patent Application Publication
(10) Pub. No.: US 2004/0094970 A1
(43) Pub. Date: May 20, 2004

(54) Latch assembly

(76) Inventor: Sidney Edward Fisher, Worcestershire (GB)

Correspondence Address: CARLSON, GASKEY & OLDS, P.C., 400 WEST MAPLE ROAD, SUITE 350, BIRMINGHAM, MI, 48009, US

(21) Appl. No.: 10/683,471

(22) Filed: Oct. 9, 2003

(30) Foreign Application Priority Data
Oct. 11, 2002 (GB) GB 0223614.9

(51) Int. Cl. E05C 1/04

(52) U.S. Cl. 292/150

(57) ABSTRACT

A latch bolt engages a striker to releasably secure a first door to a vehicle body or a second door by relative displacement of the latch towards said striker. The latch bolt moves in a first plane to releasably retain the striker. The assembly includes a wedge arrangement that substantially prevents relative movement between the latch and the striker a direction perpendicular to the first plane when in a latched condition. The wedge arrangement includes first and second lateral abutment surfaces mounted on the latch. The wedge arrangements are positioned on either side of the latch bolt in a direction perpendicular to the first plane for engagement with cooperating surfaces of the striker.

### REFERENCE TO RELATED APPLICATIONS

This patent application claims priority to Great Britain Patent Application No. GB 0223614.9 filed on Oct. 11, 2002.

### TECHNICAL FIELD

The present invention relates generally to a latch assembly for a vehicle including a latch and a striker having a co-operating wedge arrangement.

### BACKGROUND OF THE INVENTION

Light commercial vehicles, such as panel vans (vans in which the load space is enclosed), typically include a relatively large rear opening closeable by two rear doors hinged to the rear most edge of each side of the van. A latch is typically provided partially up the shut-face of one of the rear doors. The latch is arranged to latch with a complementary striker provided on the shut face of the other rear door when the doors are closed. The latch may also operate shoot bolts or supplementary latches fitted to the upper and lower edges of the door fitted with the latch where the shoot bolts or supplementary latches are arranged to engage in complementary holes or strikers in the door surround. The shoot bolts or supplementary latches provide additional latching strength to the doors when closed, resist flexing of relatively tall doors during vehicle motion and resist any attempts to force the latched doors open.

The axes of the two hinges used to mount each door should be co-axially arranged for the hingable mounting to function. The sides of these vans often converge towards the van roof, making it necessary to mount the hinges some distance below the top of the shut-face of each door. Furthermore, a significant proportion of the structural integrity of the rear of the van load space is imparted by the closed rear door. When the rear doors are open, the roof and side panels of the rear load space may deflect, and the doors may flex. The hinges can also wear over time. These factors may move the rear doors out of alignment, leading to difficulties in aligning the latch with the striker and/or the shoot bolts in the respective holes. This may cause problems latching the doors.

The deflection of the roof and side panels and of the doors during vehicle motion may lead to rattling caused by play between the latch and the striker. This may increase wear on both the latch and the striker, increasing noise.

The present invention seeks to overcome, or at least mitigate, the problems of the prior art.

### SUMMARY OF THE INVENTION

Either a latch or a striker of a latch assembly is mountable to a first vehicle door. The other of the latch or the striker is mountable to a vehicle body or to a second door of the vehicle. The latch includes a latch bolt that engages the striker to releasably secure the first door to the vehicle body or the second door by relative displacement of the latch towards said striker. The latch bolt moves in a first plane to releasably retain the striker. The latch assembly further includes a wedge arrangement that substantially prevents relative movement between the latch and the striker a direction perpendicular to the first plane when in a latched condition. The wedge arrangement includes first and second lateral abutment surfaces mounted on the latch. The wedge arrangements are positioned on either side of the latch bolt in a direction perpendicular to the first plane for engagement with cooperating surfaces of the striker.

The striker includes a mounting portion, a striker bar arranged for releasable retention to the latch bolt, and first and second spaced substantially planar surfaces arranged transverse to the axis of the striker bar. The first and second surfaces engage complementary formations of the latch and substantially prevent relative deflection perpendicular to the plane of the first and second surfaces.

In another embodiment, the wedge arrangement can also include a first abutment surface on either the latch or the striker that can engage a complementary surface on the other of the latch or the striker. The first abutment surface includes a region divergent from the first plane and a region substantially parallel to the first plane.

These and other features of the present invention will be best understood form the following specification and drawings.

### BRIEF DESCRIPTION OF THE DRAWINGS

Embodiments of the present invention will now be described, by way of example only, with reference to the accompanying drawings in which:

FIG. 1A is a view of the rear doors of a light commercial vehicle incorporating latches and strikers of the latch assembly of the present invention;

FIG. 1B is an exploded view of an alternative arrangement of latches and strikers when mounted on the rear doors of a high roof van;

FIG. 1C is an exploded view of another alternative arrangement of latches and strikers when mounted on the rear doors of a low roof van;

FIG. 1D is an exploded view of a further alternative arrangement of latches and strikers when mounted on the rear doors of a small van;

FIG. 2 is a perspective view of the latch and the striker according to the present invention in an unlatched state;

FIG. 3 is a side view of the latch and the striker of FIG. 2 in an unlatched state;

FIG. 4 is a plan view of the latch and the striker of FIG. 2 in an unlatched state;

FIG. 5 is a plan view of the latch and the striker of FIG. 2 in a latched state;

FIG. 6 is a perspective view of the latch and the striker of FIG. 2 in a latched state;

FIG. 7 is a side view of the latch and the striker of FIG. 2 in a latched state; and

FIG. 8 is a plan view of a latch assembly according to another embodiment of the present invention.

### DETAILED DESCRIPTION OF THE PREFERRED EMBODIMENT

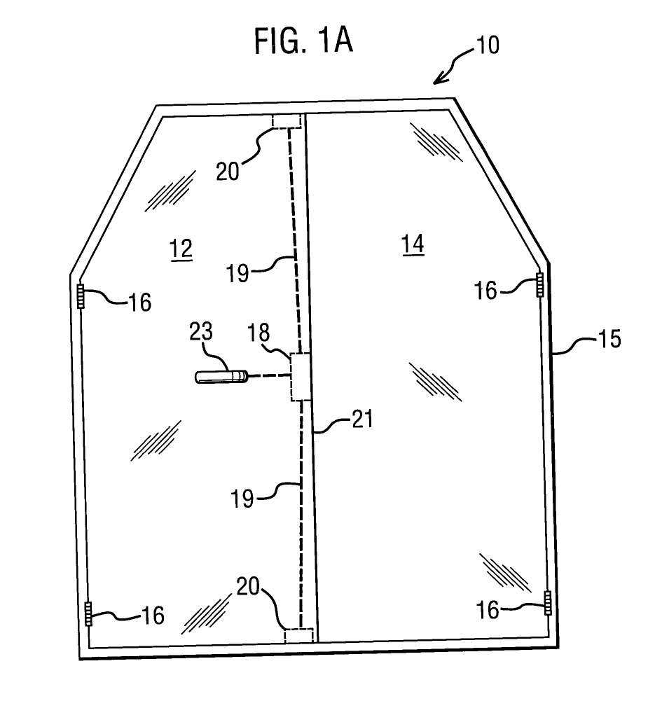

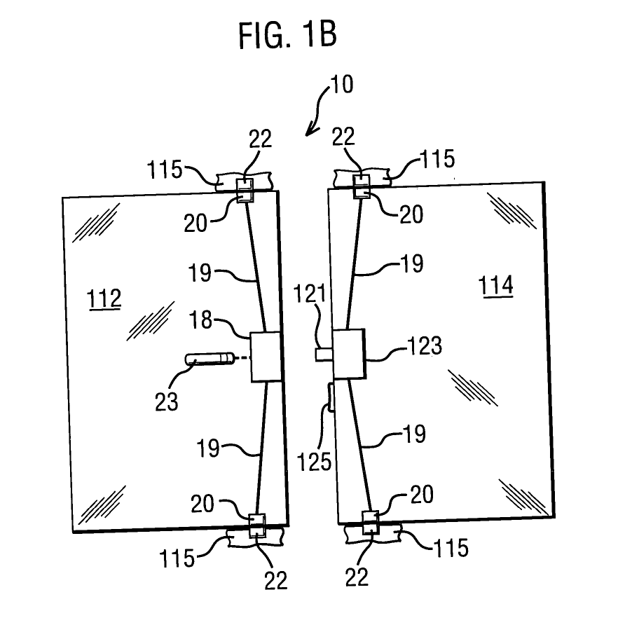

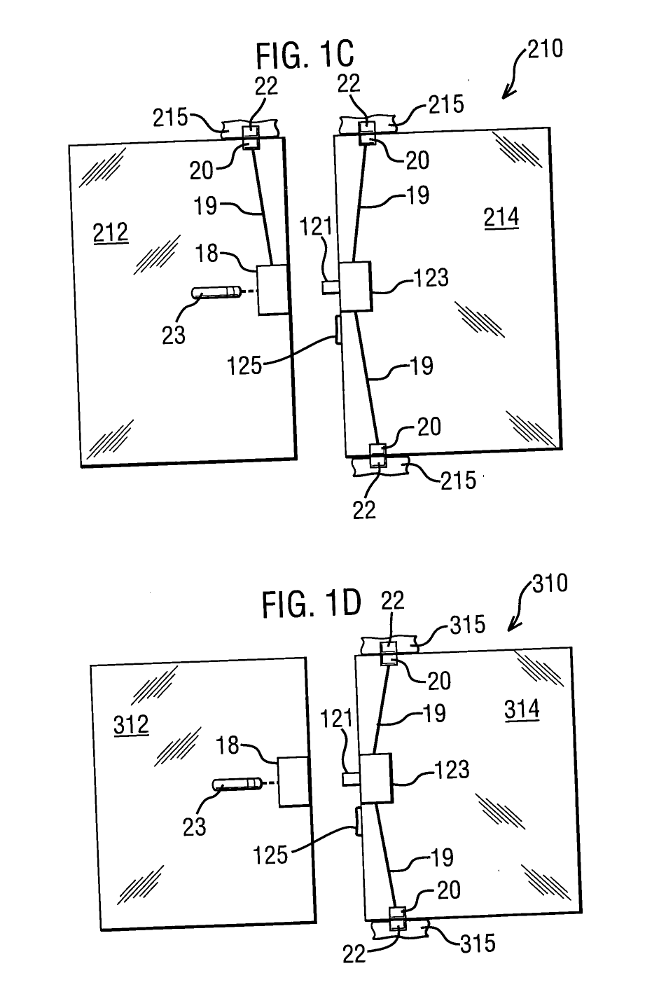

FIG. 1A illustrates the rear of a light commercial vehicle 10, such as a van. The rear of the van 10 includes a first rear door 12 and a second rear door 14 pivotally mounted to a door surround 15 by hinges 16. The first door 12 is opened first, followed by the second door 14, to gain full access to the vehicle load area. A primary latch 18 is mounted near the shut-face of the first door 12 to engage and releaseably retain a complementary striker (not shown) provided on the opposed shut-face of the second door 14. The latch 18 is lockable to prevent unauthorized access to the load space of the vehicle 10.

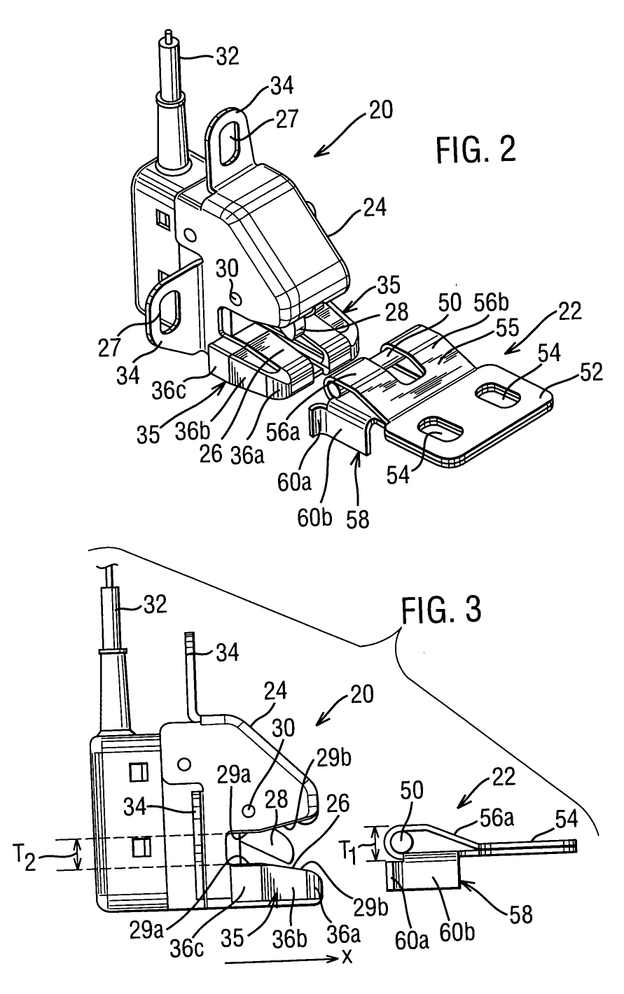

Linkages 19, such as connecting rods or Bowden cables, extend from the top and the bottom of latch 18 to connect the primary latch 18 with secondary latches 20 mounted near the top and bottom of the first door 12. The secondary latches 20 are positioned to engage the complementary strikers 22 (see FIG. 2) mounted to the door surround 15 of the vehicle 10. When the first door 12 is closed, it is latched to both the second door 14 and to the door surround 15, securely retaining both doors 12 and 14 in a closed position relative to the surround 15. An outside release handle 23 can be pulled when the latch 18 is unlocked to simultaneously release both the primary latch 18 and the secondary latches 20 (by virtue of the linkages 19).

FIGS. 1B, 1C and 1D show alternative configurations of the secondary latches 20 and the strikers 22 when fitted to a high roof line, a low roof line and a small van 110, 210, and 310, respectively. The primary latch 18 is fitted to a first door 112, 212 and 312 and a corresponding primary striker 121 is mounted to a central opening plate 123 of a second door 114, 214 and 314. A secondary release handle 125 is mounted to the shut face of the second door 114, 214, 314 and is only accessible to a vehicle user when the first door 112, 212, 312 is open. The secondary release handle 125 is operably connected to a release mechanism (not shown) within the central opening plate 123, and actuation of the secondary release handle 125 causes the latches 20 mounted on the door surround 115, 215, 315 to release from the striker 22.

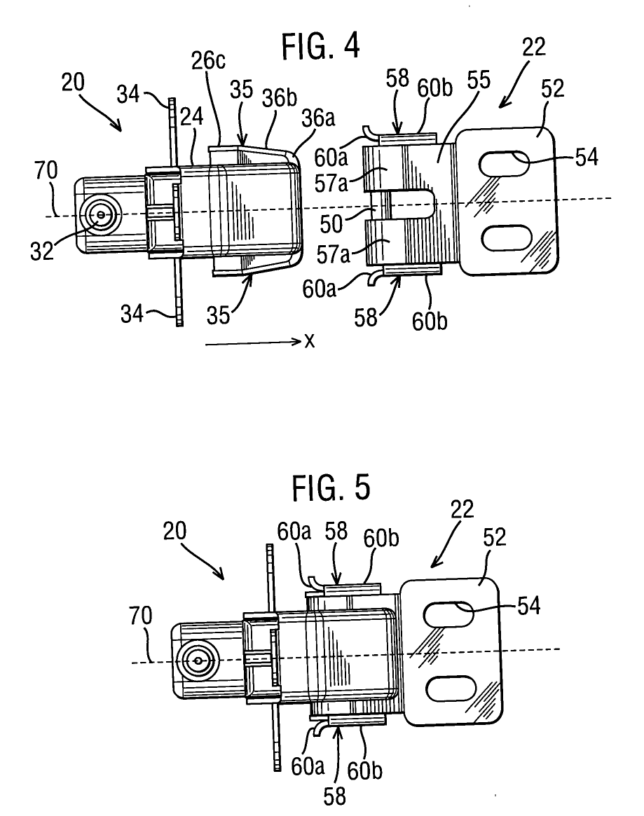

FIGS. 2, 3 and 4 show a first embodiment of a secondary latch 20 and a striker 22 in a latch assembly in an unlatched condition. The latch 20 includes a housing 24 having a mouth 26 arranged to receive the striker 22. The housing 24 includes mounting brackets 34 having slotted apertures 27 to mount the latch to the door 12. The slotted apertures 27 allow some adjustment of the housing 34 relative to the door 12 during mounting.

A latch bolt in the form of a rotatable claw 28 is pivotally mounted within the housing 24 by a pin 30. The claw 28 is resiliently biased into the open position, as shown in FIGS. 2 and 3. A latch mechanism (not shown) connects the claw 28 to the linkage 19 from the primary latch 18, which is a Bowden cable 32 in this embodiment.

As shown in FIGS. 5, 6 and 7, when the striker 22 is introduced into the mouth 26, the claw 28 rotates and is releasably retained by a pawl (not shown) of the latch mechanism. In this embodiment, the latch 20 does not include a locking mechanism since the locking function is provided in the primary latch 18. However, a suitable known locking mechanism may be incorporated into the latch 20.

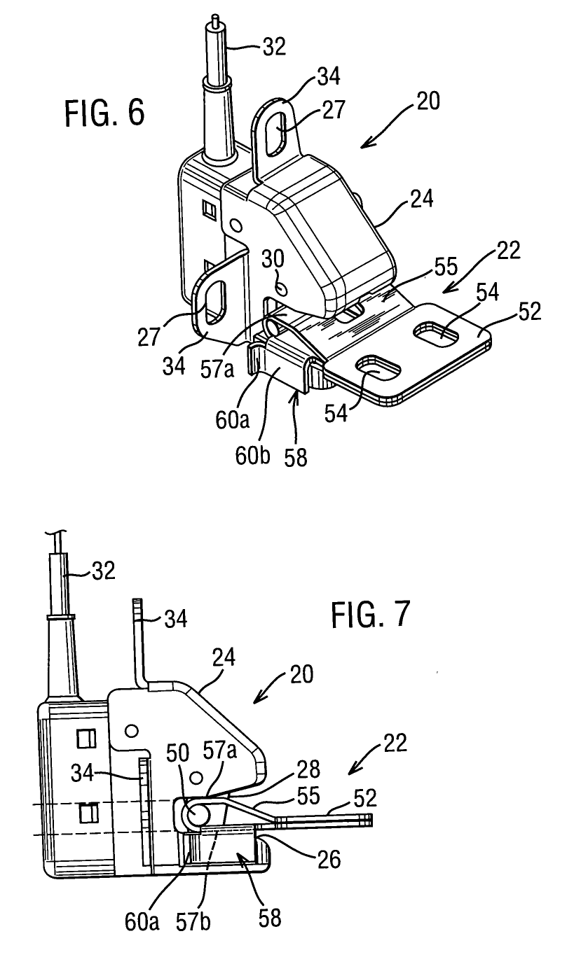

The claw 28 rotates about the pin 30 and moves in a first plane 70 from the released position shown in FIGS. 2 and 3 to the latched position shown in FIGS. 6 and 7. When the latches 20 are installed as shown in FIGS. 1A, 1B, 1C and 1D, the first plane 70 is substantially vertical and essentially parallel to the pivoting axes of the doors 12 and 14. However, it is to be understood that other installations are possible.

Portions of the top and the bottom of mouth 26 (on either side of the claw 28) are preferably resilient and define first and second vertical abutment surfaces that are substantially perpendicular to the first plane. In one example, the resilience permits a maximum deflection of 1 mm for a 1000 N load. The surfaces include mutually parallel inner regions and divergent outer regions. A spacing T₂ is between the parallel inner regions. Alternately, the first and second vertical abutment surfaces may be provided on only one side of the claw.

A first lateral wedge arrangement portion including a first lateral abutment surface 35 is provided on a side face of the housing 24 beneath the mouth 26 when oriented as shown in FIGS. 2 and 3. In this embodiment, the first lateral abutment surface 35 includes three distinct regions. From the front to the rear of the latch (from the opening of mouth 26 in a direction towards mounting brackets 34), the first lateral abutment surface 35 includes a first chamfered region 36a, a second region 36b divergent from the first plane 70, and a third region 36c substantially parallel to the first plane 70. In this embodiment, a second lateral abutment surface 35 is provided on the opposite side face of the housing 24 and is a mirror image of the first lateral abutment surface 35. The first and second lateral abutment surfaces 35 are preferably resiliently deformable. Typically, the resilience is such that a 500 N loading transverse to the first plane 70 causes a deflection of less than 0.5 mm.

The first lateral wedge portion can be made of a substantially non-compressible plastic material having a live hinge at its connection to the front of the latch. A small spacing between the portion and the latch housing provides a predetermined amount of resilience.

The striker 22 includes a striker bar 50 sized to engage with the claw 28. The striker 22 further includes a shaped sheet portion that holds the striker bar 50 at each end and having an appropriate formation to mount the striker 22 to the door surround 15. The shape of the sheet portion is stamped or cut from a blank to form the striker 22. The blank is then folded to retain the striker bar 50 and to form a striker bar supporting region 55 and a double thickness mounting region 52. The striker bar 50 is welded or otherwise secured to the sheet portion. The mounting region 52 is provided with slotted apertures 54 that enable the striker 22 to be screwed or bolted to the door surround 15 with some degree of adjustability, enabling the striker 22 to be correctly aligned with the latch 20.

The supporting region 55 includes legs 56a and 56b that hold and support both ends of the striker bar 50 and define a gap having a size sufficient to enable the striker bar 50 to engage the claw 28. The legs 56a and 56b preferably include third and fourth vertical abutment surfaces having parallel planar regions 57a and 57b above and below the striker bar 50. The spacing T₁ between the regions 57a and 57b is substantially equal to or slightly larger than the spacing T₂ between the regions 29a and 29b. Together, the third and fourth vertical abutment surfaces of the legs 56a and 56b and the mouth 26 define a vertical wedge arrangement.

A second lateral wedge arrangement portion including a third lateral abutment surface 58 is formed from an integral downwardly folded portion of the leg 56a. The third lateral abutment surface 58 includes two distinct regions. From the front of the striker 22 (the end nearest the striker bar 50), the third lateral abutment surface 58 includes a guide member in the form of an outwardly curved mouth region 60a and a planar region 60b substantially parallel to the first plane 70 when the striker 22 is retained by the latch 20. In this embodiment, a fourth lateral abutment surface 58 is provided by a downwardly turned portion of the other leg 56b, the fourth lateral abutment surface 58 being a mirror image of the third lateral abutment surface 58.

When the door including the latch 20 mounted in a direction X is closed, any misalignment between the latch 20 and the striker 22, up to a predetermined limit in a lateral direction, is overcome by engagement of one of the chamfered regions 36a of the first or the second lateral abutment surfaces 35 with the corresponding curved region 60a of the third or the fourth lateral abutment surfaces 58, correctly guiding the latch 20 into horizontal alignment with the striker 22 and permitting engagement. Engagement of the front curved region of the legs 56a and 56b with the enlarged opening of the mouth 26 overcomes vertical alignment up to a predetermined limit, bringing the latch 20 into correct vertical alignment with respect to the striker 22.

As closure continues, the claw 28 contacts the striker bar 50 to rotate the claw 28 and releaseably retain the striker 22 in the fully latched condition, shown in FIGS. 5, 6 and 7. If there is insufficient relative movement to bring the latch to a fully latched condition, the pawl can retain the claw 28 in an “almost closed” first safety position (not shown), which would also retain the latch 20 on the striker 22.

As the claw 28 rotates, the planar regions 60b of the third and the fourth lateral abutment surfaces 58 are guided by the divergent regions 36b of the first and the second lateral abutment surfaces 35, progressively overcoming the resilience of the abutment surfaces 35 to rest on the parallel regions 36c. A certain amount of compressive force is exerted between the first and the second lateral abutment surfaces 35 and the regions 60b of the third and the fourth lateral abutment surfaces 58 when in this position. The compressive force minimizes any possible horizontal movement at the latch 20 and the striker 22 when latched. Furthermore, the spacing T₁ of the striker 22 relative to the spacing T₂ of mouth 26 minimizes any potential relative vertical movement between the striker 22 and the latch 20 since the top and/or the bottom resilient portions of the mouth 26 are preferably forced into compression.

The above described arrangement minimizes or substantially prevents relative movement between the latch 20 and the striker 22 in both the vertical and the lateral direction, while also enabling successful latching to occur despite a degree of misalignment between the positions of the latch 20 and the striker 22 during door closure.

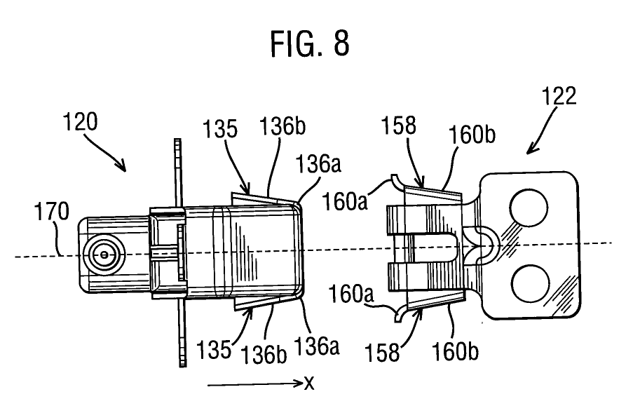

FIG. 8 shows the latch 120 and the striker 122 having an alternate lateral wedge arrangement according to the second embodiment of the present invention. The regions 160b of the third and fourth lateral abutment surfaces 158 diverge from the first plane 170. The first and the second lateral abutment surfaces 135 do not include a region parallel with the first plane 170. Therefore, as the latch 120 engages the striker 122, additional movement of the latch in the closure direction X causes additional compressive forces to be exerted between the first lateral wedge arrangement portion and second lateral wedge arrangement portion. In the first embodiment, a maximum compressive force is reached as the region 60b rests on the region 36c.

It should be appreciated that the terms used to describe the orientation of the various latch 20 and striker 22 components in the description have been used for ease of understanding and should not be regarded as limiting. The latch 20 and striker 22 of the present invention may be orientated in any direction as required by the latching of one to the other.

It will be appreciated that numerous changes may be made within the scope of the present invention. For example, some applications may require only first and second lateral wedge arrangement portions 35 having one abutment surface each. Additionally, it will be appreciated that the second lateral wedge arrangement portion 58 may be provided on the latch 20 and the first lateral wedge arrangement portion 35 on the striker 22. The construction of both the striker 22 and latch 20 may be altered. Furthermore, the invention may be applied to other types of latch 20 which do not operate using a rotatable claw type latch bolt. The lateral wedge arrangement portion may be provided above, rather than below, the mouth 26.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A latch assembly comprising:
a latch including a mouth, a latch bolt moveable in a first plane, and a first lateral abutment surface and a second lateral abutment surface mounted on the latch and positioned on opposing sides of the latch bolt in a direction substantiallyl perpendicular to the first plane, wherein the latch is mountable to one of a first vehicle door and one of a vehicle body and a second vehicle door;
a striker including a striker bar, wherein the striker is mountable to the other of the first vehicle door and the other of the vehicle door and the second vehicle door, and wherein engagement of the latch bolt of the latch and the striker releasably secures the first vehicle door to the one of the vehicle body and the second vehicle door by relative displacement of the latch towards the striker; and
a wedge arrangement including the first lateral abutment surface and the second lateral abutment surface that engages cooperating surfaces of the striker.

2. The assembly according to claim 1 wherein the wedge arrangement includes a guide at a front of the first abutment surface to assist the latch into engagement with the striker during the relative displacement of the latch towards the striker.

3. The assembly according to claim 1 wherein the first abutment surface includes a region divergent from the first plane.

4. The assembly according to claim 1 wherein the first abutment surface includes a region substantially parallel to the first plane.

5. The assembly according to claim 1 wherein the first abutment surface includes a first region and the second abutment surfaces include a second region divergent from the first region.

6. The assembly according to claim 1 wherein the first abutment surface has a first parallel region and the second abutment surfaces has a second parallel region spaced apart from and substantially parallel to the first parallel region.

7. The assembly according to claim 1 wherein the wedge arrangement is resiliently deformable.

8. The assembly according to claim 1 wherein the striker includes a striker bar portion.

9. The assembly according to claim 8 wherein the striker is engagable with the latch bolt.

10. The assembly according to claim 8 wherein the striker includes a first arm and a second arm that retain ends of the striker bar.

11. The assembly according to claim 10 wherein a portion of the wedge arrangement is integral with at least one of the first arm and second arm.

12. The assembly according to claim 1 further including a second wedge arrangement arranged to substantially prevent relative movement between the latch and the striker in a direction substantially parallel to the first plane when the latch assembly is latched.

13. The assembly as recited in claim 1 wherein the latch assembly adapted for use in a vehicle.

14. A striker for releasable securement to a latch including a latch bolt having a mouth and formations, the striker comprising:
a mounting portion;
a striker bar having an axis to releaseably retain the latch bolt;
a first substantially planar surface and a second substantially planar surface spaced apart from the first substantially planar surface, wherein the first substantially planar surface and the second substantially planar surface are transverse to the axis of the striker bar and engage the formations of the latch and substantially prevent relative deflection perpendicular to a plane of the first substantially planar surface and the second substantially planar surface.

15. A latch assembly comprising:
a latch including a mouth, a latch bolt moveable in a first plane, wherein the latch is mountable to one of a first vehicle door and one of a vehicle body and a second vehicle door;
a striker including a striker bar, wherein the striker is mountable to the other of the first vehicle door and the other of the vehicle door and the second vehicle door, and engagement of the latch bolt of the latch and the striker releasably secures the first vehicle door to the one of the vehicle body and the second vehicle door by relative displacement of the latch towards the striker; and
a wedge arrangement including a first abutment surface on one of the latch and the striker engagable with a complementary second abutment surface on the other of the latch and the striker, wherein the first abutment surface includes a first region that diverges from the first plane and a second region substantially parallel to the first plane.

16. The assembly according to claim 15 wherein the wedge arrangement includes a guide at a front of the first abutment surface to assist the latch into engagement with the striker during the relative displacement of the latch towards the striker

17. The assembly according to claim 15 wherein the wedge arrangement includes a first region and second region that diverges from the first region.

18. The assembly according to claim 15 wherein the wedge arrangement includes a first region and a second region that is parallel to the first region.

19. The assembly according to claim 15 wherein the wedge arrangement is resiliently deformable.

20. The assembly according to claim 15 wherein the striker is engagable with the latch bolt.
